(19) United States
(12) Patent Application Publication
(10) Pub. No.: US 2021/0209239 A1
(43) Pub. Date: Jul. 8, 2021

(54) ELECTRONIC CONTENT LAYER CREATION WITH ASSOCIATED ACCESS AND EDIT PERMISSIONS

(71) Applicant: Hewlett-Packard Development Company, L.P., Houston, TX (US)

(72) Inventor: Ian N. Robinson, Pebble Beach, CA (US)

(73) Assignee: Hewlett-Packard Development Company, L.P., Houston, TX (US)

(21) Appl. No.: 16/072,130

(22) PCT Filed: May 6, 2016
(86) PCT No.: PCT/US2016/031347

§ 371 Date: Jul. 23, 2018

(51) Int. Cl. G06F 21/62; G06F 3/0484; G06F 3/0486

(52) U.S. Cl. CPC G06F 21/6209; G06F 2221/2141; G06F 3/0486; G06F 3/04842

(57) ABSTRACT

Examples disclosed herein relate to electronic content layer creation with associated access and edit permissions. In one implementation, a processor stores a first electronic content layer created by a first user and associated with access permissions including a second and third user. The process may create a second electronic content layer based on the first electronic content layer as edited by the second user and create a third electronic content layer based on the first electronic content layer as edited by the third user. The processor may store the second and third electronic content layers and associated permission types with the second and third electronic content layers.

### BACKGROUND

Messaging and video conferencing applications allow for users to collaborate with one another. Such applications may provide users with tools to better communicate with others in remote locations. For example, users may make documents or presentations viewable to their collaborators. In some cases, the shared documents may include free form edits, such as content created by a smart pen.

### BRIEF DESCRIPTIONS OF THE DRAWINGS

The drawings describe example embodiments. The following detailed description references the drawings, wherein:

FIG. 1 is a block diagram illustrating one example of a computing system to create an electronic content layer with associated access and edit permissions.

FIG. 2 is a flow chart illustrating one example of a method to create an electronic content layer with associated access and edit permissions.

FIG. 3 is a diagram illustrating one example of creating an electronic content layer with associated access and edit permissions.

FIG. 4 is a diagram illustrating one example of creating an electronic content layer based on merging existing electronic content layers.

FIG. 5 is a diagram illustrating one example of a configuration used for collaboratively viewing and/or editing electronic content layers.

### DETAILED DESCRIPTION

In one implementation, a computing system allows for collaboration between users of electronically created and/or edited content, such as sketches created using computing applications that allow free form additions to an image, document, or other medium. For example, a processor may create and store an electronic content layer such that the electronic content layer is associated with an edit permission and access permission. The content displayed to a user in a collaborative session may exist on multiple electronic content layers, each adding to the one below it, and the electronic content layers visible to a particular user may be limited to those to which the user has access permissions.

In one implementation, a processor causes a user interface to be displayed to receive user input related to selecting a first electronic content layer created by a first user to be copied to create a second electronic content layer. The processor may assign a permission to the second electronic content layer, such as to the user selecting to create the second electronic content layer. The user interface may also receive user input related to editing the newly created second electronic content layer and to selecting access permissions information to associate with the second electronic content layer. The processor may store information related to the second electronic content layer and publish information about the second electronic content layer to users with associated access permissions to the second electronic content layer.

As an example, a first user may create and/or edit a first electronic content layer, such as where the first electronic content layer edit and access permissions are limited to the first user, and the first user may later associate an access permission such that the layer becomes visible to a second and third user. The second and third users may contribute content in shared electronic content layers on top of the shared electronic content layer created by the first user. For example, the second user may copy the first electronic content layer to create a new electronic content layer with edit permissions limited to the second user, and the second user may edit the newly created electronic content layer and/or create a second electronic content layer to place over the new electronic content layer. In one implementation, electronic content layers may be combined, such as where unedited portions serve as transparent to the previous electronic content layer.

An edit permission may be associated with a first electronic content layer created by a first user, such as where the creator of the layer is automatically provided edit permissions or where the edit permissions may be selected by a user or based on a set of criteria. In one implementation, the edit permission is limited to a number of users, such as where the edit permission is limited to the creator of the electronic content layer. An access permission may be associated with any suitable type of access, such as viewing, copying, or downloading access permissions. For example, a second user may create a second electronic content layer using content from the first electronic content layer with edit permissions associated with the second user, and a third user may create a third electronic content layer using content from the first electronic content layer with edit permissions associated with the third user. Editing in separate layers, the second and third users may edit the content from the first electronic content layer differently and without altering the first electronic content layer. The second and third electronic content layers may initially have access permissions limited to the creator, such as where the third user may not view the second electronic content layer and the second user may not view the third electronic content layer. The second and third user may update the access permissions to allow the electronic content layers to be shared, such as where other users may view or copy the second and third electronic content layer.

An electronic content layer computing system allowing multiple access and edit permission types may allow for more flexible free form collaboration, such as collaboration in an electronic sketching environment. A sketching application, for example a white boarding application, with electronic content layers may allow flexible editing in an unstructured environment, such as in a drawing environment where free form additions using a smart pen or other input method may be added to electronic content by multiple users simultaneously. Electronic content layers may promote collaboration by allowing users to independently contribute content on the layer or layers editable by the particular user, and electronic content layers may be combined together from multiple users to form a new electronic content layer, allowing multiple users to contribute to an overall composited result. The computing system may allow users to create and/or edit content on a layer visible to others, or on a layer with access permissions limited to the particular user which may be updated to include additional users so that the content may be shared. Shared content may be copied by other users with access permissions to the shared electronic content layers such that the other users may create new electronic content layers of their own, taking advantage of content previously created by others. As a result, a layered sketching computing system may provide greater versatility such that edits are not limited to a set of defined options, such as based on dragging and dropping components or using public templates.

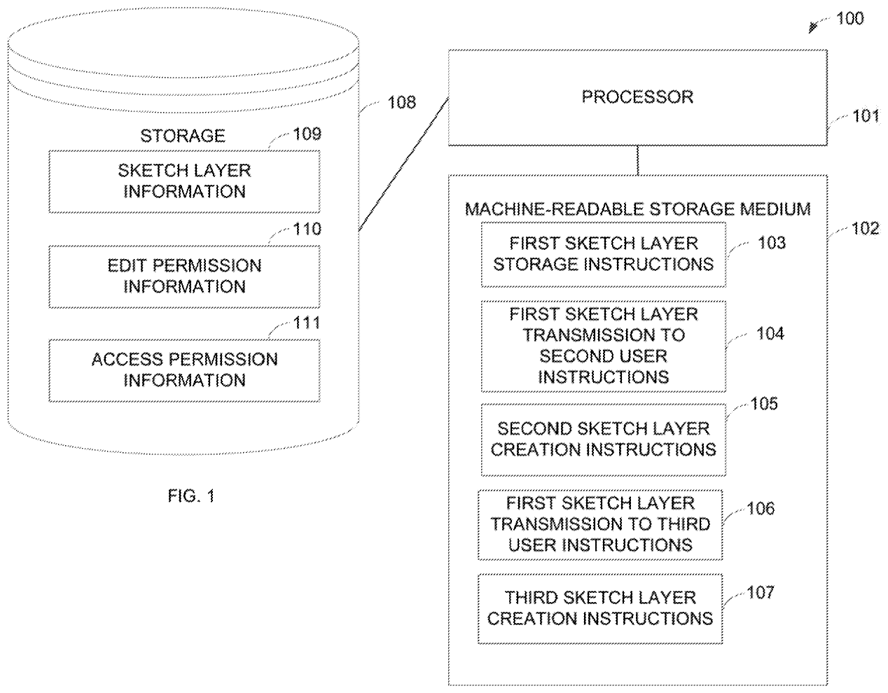

FIG. 1 is a block diagram illustrating one example of a computing system to create an electronic content layer with associated access and edit permissions. The computing system 100 may provide a collaborative environment to allow multiple users to create and share content. The computing system 100 may include an electronic content collaboration cloud service such that multiple users with separate computing devices may communicate with the computing system 100 via a network to create collaborative designs among multiple users. The collaborative designs, may include free form sketches, such as using a stylus or smart pen. The computing system 100 includes a processor 101, machine-readable storage medium 102, and storage 108.

The processor 101 may be a central processing unit (CPU), a semiconductor-based microprocessor, or any other device suitable or retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The storage 108 may be any suitable storage to store information related to electronic content layer information. The computing system 100 may include any suitable number of storage devices. For example, the storage 108 and 102 may be combined into the same storage. In one implementation, the processor 101 communicates with multiple storages via a network. The storage 108 may communicate with the processor 101 directly or via a network to provide or receive information related to electronic content layers. The storage 108 may include electronic content layer information 109, edit permission information 110, and access permission information 111.

The electronic content layer information 109 may include any suitable information related to electronic content layers, such as electronic content layers created by multiple users using different computing devices, such as where the information is received by the process 101 from the computing devices via a network. An electronic content layer include any suitable electronic content, such as text, images, and user created annotations. The electronic content layer may include some components of user free hand sketching, such as using a stylus or smart pen. For example, the sketching may be related to annotating existing content or drawing standalone content.

The edit permission information 110 may include information related to ability to edit an electronic content layer. In one implementation, the edit permission is limited to the author or creator of the electronic content layer. The access permission information 111 may include information related to the ability to access an electronic content layer, such as to view or copy an electronic content layer. The access permission information 111 may indicate an ability to copy an electronic content layer or a portion of an electronic content layer to create a new electronic content layer with edit permission information different than the original copied electronic content layer. In one implementation, each electronic content layer is associated with an edit and access permission type. The edit and access permission types may be updated, such as where a user selects to update an access permission to remove access permissions of other users and limit access, such as visibility of the electronic content layer, to themselves. Likewise, a user may update access permissions to include more users, such as after the user completes some edits to the particular electronic content layer. As another example, a first user may select another user to edit an electronic content layer with or instead of the first user.

The processor 101 may communicate with the machine-readable storage medium 102. The machine-readable storage medium 102 may be any suitable machine readable medium, such as an electronic, magnetic, optical, or other physical storage device that stores executable instructions or other date (e.g., a hard disk drive, random access memory, flash memory, etc.). The machine-readable storage medium 102 may be, for example, a computer readable non-transitory medium. The machine-readable storage medium 102 may include first electronic content layer storage instructions 103, first electronic content layer transmission to second user instructions 104, second electronic content layer creation instructions 105, first electronic content layer transmission to third user instructions 106, and third electronic content layer creation instructions 107.

The first electronic content layer storage instructions 103 may include instructions to store a first electronic content layer received from a first user computing device in the storage 108 and to store an associated edit permission information 110 indicating the first user and access permission information 111 including a second user. For example, the edit permission information 110 may be limited to the first user and/or include the first user in a set of users with the ability to edit the first electronic content layer. The access permission information 111 may include the second user, and may be, for example, public, limited to the second user, or include a set of users including the second user.

The first electronic content layer transmission to second user instructions 104 may include instructions to transmit information, such as via a network, related to the first electronic content layer to a second computing device associated with the second user. For example, the transmission may be in response to a request from the second user to view or copy the first electronic content layer. In one implementation, the processor makes information about the first electronic content layer viewable by the second user, and the second user may provide user input to request to view the first layer or copy the first layer, such as to download the first electronic content layer or to view the electronic content layer using a web interface. The processor may create the second electronic content layer as a copy of the first electronic content layer and transmit the second electronic content layer as a copy of the first electronic content layer or may transmit the first electronic layer and subsequently create a new electronic content layer.

The second electronic content layer creation instructions 105 may include instructions to create a second electronic content layer based on the first electronic content layer. For example, the second electronic content layer may be associated with an edit type associated with the second user such that the second user can edit the second electronic content layer. The second electronic content layer may include the first electronic content layer content in its entirety or portions of the first electronic content layer content. For example, the processor may causer a user interface to be displayed to allow a user to lasso or otherwise select content on the first electronic content layer to be placed on the second electronic content layer.

In one implementation, the second electronic content layer may include content from multiple electronic content layers. For example, the processor may automatically merge content from multiple electronic content layers, potentially contributed to by multiple different users, to add content to an electronic content layer, or the processor may automatically merge content from a first electronic content layer onto an electronic content layer being created by a user. As an example, a user may create an electronic content layer with some content and select to merge content from another electronic content layer onto the electronic content layer. In one implementation, the second user may create multiple electronic content layers from the second electronic content layer, such as third electronic content layer and a fourth electronic content layer such that a user may add information to the third electronic content layer and add different information to the fourth electronic content layer.

The first electronic content layer transmission to third user instructions 106 may include instructions to transmit information related to the first electronic content layer to a third computing device associated with a third user. The transmitted information may be related to a new content layer based on the first electronic content layer or information related to the first electronic content layer itself. The first electronic content layer may include access permissions including the third user such that the third user may download the first electronic content layer or have permission to access the first electronic content layer via a web interface. The first electronic content layer information may be transmitted in response to user input indicating the selection of the first electronic content layer, such as by the first user or by the third user, to be provided to the third user.

The third electronic content layer creation instructions 107 may include instructions to create a third electronic content layer based on the first electronic content layer. For example, the third electronic content layer may be associated with an edit permission type associated with the third user. The third electronic content layer may include content added and/or edited by the third user, portions of other electronic content layers, and/or merged content from other electronic content layers.

In one implementation, the processor associates and/or stores access permissions with the third electronic content layer. In one implementation, the access permissions may be selected by a user with edit permissions associated with the electronic content layer. In one implementation, the processor automatically determines and associates access permissions, such as based on an automated workflow process. The access permission may relate to, for example, a single user, group of users, private permission type, and/or public permission type. The processor may output information related to the third electronic content layer such as to transmit, display, and/or store the third electronic content layer, for example, to make it available to other users to edit the third electronic content layer. For example, a new electronic content layer a user creates may by default only be accessible (such as visible and/or copyable) by that user. The user may then be able to choose to make the electronic content layer accessible to more users, such as by using a user interface input button or other input option.

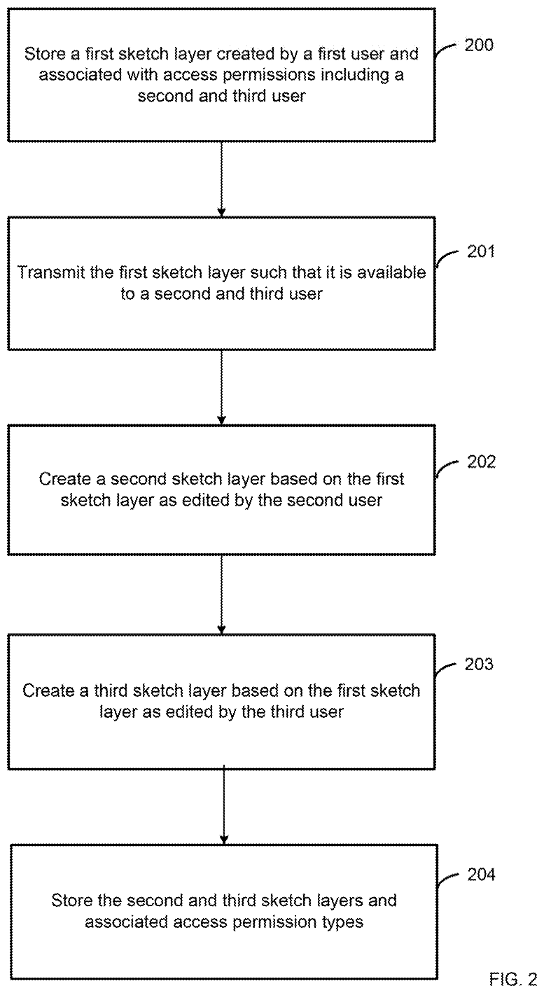

FIG. 2 is a flow chart illustrating one example of electronic content layers with associated access and edit permissions. An electronic content layer may facilitate collaboration by allowing multiple users to view, copy, and/or different electronic content layers created and/or edited by different users. For example, a first user may create first electronic content layer with edit and access permissions associated with the first user. The access permissions may be updated to allow other users to view and copy the first electronic content layer such that the other users may create their own individual electronic content layers on top of the content of the first electronic content layer. The method may be implemented, for example, by the computing system 100 of FIG. 1.

Beginning at 200, a processor stores a first electronic content layer created by a first user and associated with access permissions including a second and third user. For example, an electronic content layer may include a particular version of content such that users may create and share different layers, create subsequent layers based on previous layers, and/or revert back to previous layers. The storage may be any suitable storage for storing information about electronic content layers and associated permissions information. In one implementation, the storage stores relationships between layers, such as to indicate when a subsequent electronic content layer is created from a previous electronic content layer. The access permissions may indicate, for example, that a user may view, copy, and/or download the associated electronic content layer. For example, the access permissions may associate a user or user group with the type of available access. In one implementation, the access permission does not have multiple types, and a user with access permissions may view, copy, and download the associated electronic content layer to which the user has access permissions. The first, second, and third user may be in physical proximity to one another or may be remote, and the first, second, and third users may use the same or different electronic devices than one another to view and create electronic content layers.

Continuing to 201, a processor transmits information related to the first electronic content layer such that it is available to a second and third user. For example, the processor may access electronic content layer information from the storage and make it available to users at other computing devices. The first electronic content layer may be public and/or have permissions such that it is viewable and/or copyable by the first and second users. The transmitted information may related to the first electronic content layer and/or an electronic content layer created based on the first electronic content layer. For example, the processor may transmit a second version of the first electronic content layer to the second user and a third version of the first electronic content layer to the third user such that the second and third user may alter the information related to the first electronic content layer differently than one another.

Continuing to 202, a processor create a second electronic content layer based on the first electronic content layer as edited by the second user. For example, the first electronic content layer may be available to the first user, such as where the first user may download or access the first layer at a computing device. The first electronic content layer version accessed by the first user may form a second electronic content layer such that the first user may edit the second electronic content layer without affecting the first electronic content layer. The first user may, for example, add, remove, or alter content on the second electronic content layer as compared to the first electronic content layer. The first electronic content layer may be edited in any suitable manner, such as using a smart pen, keyboard, gesture, or other input type.

In one implementation, a process associates a permission type with the second electronic content layer. The processor may associate multiple permission types with the second electronic content layer, such as a first permission setting associated with ability to edit the second electronic content layer and a second permission setting associated the ability to view and/or duplicate the second electronic content layer.

In one implementation, the first user may create multiple electronic content layers, such as where the first user may copy multiple versions of the first electronic content layer into multiple electronic content layers to alter the electronic content layers differently. In one implementation, the processor allows the first user to create sequential electronic content layers, such as where the first creates some edits to the second electronic content layer and then creates a subsequent electronic content layer from the edited second electronic content layer such that further edits are created on the third electronic content layer and/or different edits may be made afterwards on the second electronic content layer. The first user may select access permissions for each of the created layers.

Continuing to 203, a processor creates a third electronic content layer based on the first electronic content layer as edited by the third user. For example, a different electronic content layer may be created for the second user such that both the first and second user may separately edit the first electronic content layer to add their own additions.

A processor may associate an access permission type with the third electronic content layer, such as where the third user, a set or specific users, or a user group may be provided access permissions to the third electronic content layer. In one implementation, the processor associates multiple permissions settings with the third electronic content layer, such as different permissions settings for editing, viewing, and/or duplicating the third electronic content layer. The third user may have permission to edit the third electronic content layer. In one implementation, the third user may add additional users that have edit permissions.

Continuing to 204, a processor stores the second and third electronic content layers and associated access permission types. In one implementation, the permissions associated with an electronic content layer may be altered. For example, a processor may cause a user interface to be displayed to allow a user to change the permissions associated with the electronic content layer associated with the user. As an example, a user may edit an electronic content layer with a private view permission setting and change the setting to public once the user is finished editing such that other users may view or duplicate the electronic content layer. In one implementation, an edit permission for an electronic content layer is limited to a single user, and a user may relinquish the electronic content layer to allow another user to edit the electronic content layer. The processor may search the storage for information about existing electronic content layers, such as to search related to layers viewable to a specific user or group, created by a user or group of user, and/or based on an electronic content layer created by a user or group.

In one implementation, the processor allows a user options to edit electronic content layers. For example, the processor may allow a user to create a new electronic content layer from multiple electronic content layers, such as where the processor automatically merges two electronic content layers or where the processor allows a user to identify portions of a first electronic content layer and place it on a second existing electronic content layer. For example, the processor may provide a user interface to allow a user to lasso or otherwise identify a selection to be added to an electronic content layer.

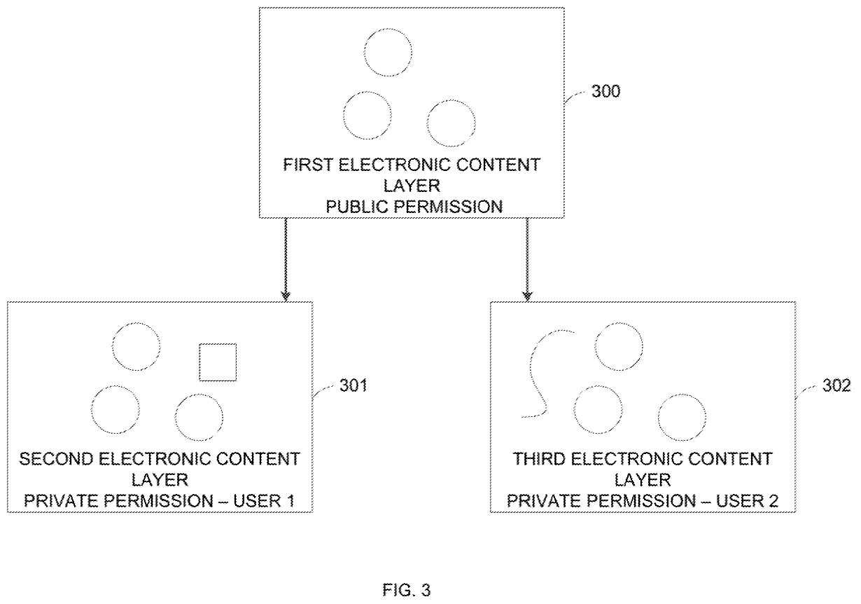

FIG. 3 is a diagram illustrating one example of creating an electronic content layer with associated access and edit permissions. First electronic content layer 300 is associated with permissions with a public permission, such as where multiple users may view or duplicate the first electronic content layer 300.

A first and second user may select the first electronic content layer and duplicate the first electronic content layer to create private electronic content layers editable by the specific users. For example, the second electronic content layer 301 may include the first electronic content layer plus additions created by the first user. For example, the first user may create a second electronic content layer from the first electronic content layer or create a blank electronic content layer and add content from the first electronic content layer. The second electronic content layer may be associated with edit permissions of the user 2.

The third electronic content layer 302 may be associated with a private edit permission for user 3, such as where user 3 may edit the third electronic content layer 302. In one implementation, the third electronic content layer 302 is associated with a separate view permission such that other users may view the changes being made by user 3 either as user 3 edits the layer or after user 3 saves the changes to the layer.

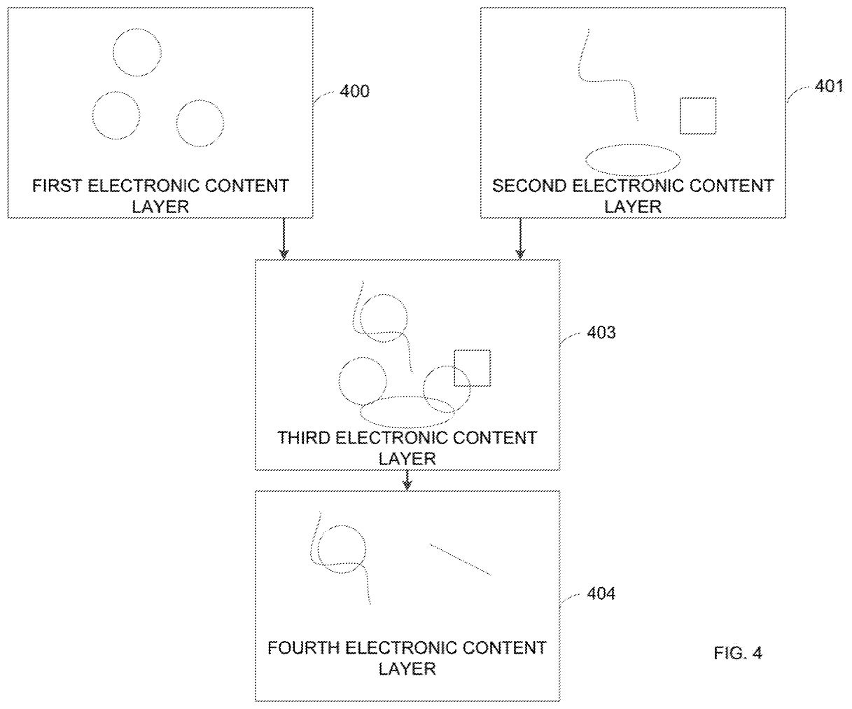

FIG. 4 is a diagram illustrating one example of creating an electronic content layer with content obtained by merging existing electronic content layers, such as using a computing system that allows for content to be created on separate layers and selected, merged, and otherwise editing between layers. In one implementation, a processor allows for portions of different electronic content layers to be selected and merged together.

The processor may allow for multiple electronic content layers to be merged in any suitable manner. In one implementation, a user may select a portion of content from a first electronic content layer and place it on a second electronic content layer, such as in a different position. In one implementation, the processor automatically superimposes multiple electronic content layers on top of one another. The processor may provide a tool for a user to adjust the superimposed electronic content layers, such as to adjust the relative positions. The superimposed electronic content layers may be viewed as a single image. An edit to the composite electronic content layers may be performed, for example, on the top electronic content layer, or a new electronic content layer may be created based on the composite electronic content layers such that the separate electronic content layers become a single electronic content layer. In one implementation, a lasso or other selection tool may be provided to allow a user to select a portion of the content resulting from a stack of electronic content layers, and the user interface may allow the user to select a destination electronic content layer for the merged content to be copied to and/or allow the user to select the position and size of the merged and copied selected content.

As an example, the first electronic content layer 400 shows a first electronic content layer with sketched content, and second electronic content layer 401 shows a second electronic content layer with different sketched content. In one implementation, a processor allows a user to select electronic content layers to merge together into a new layer. The merged electronic content layers may be, for example, created by the same user or by different users. As an example, three layers each created by different users may be merged together into a layer for a new user to create a new electronic content layer from which a user may add additional sketching or other edits onto the merged layer. The third electronic content layer 402 shows a new electronic content layer created by superimposing the first electronic content layer 400 onto the second electronic content layer 401. The fourth electronic content layer 403 shows an electronic content layer created based on a selection of the third electronic content layer 402 such that the selection is moved to a new position and additional content is added.

Each of the four electronic content layers 401-404 may have different users associated with the edit permissions for the different electronic content layers and may have different users associated with the access permissions for the different electronic content layers. As an example, a first users may have access permissions to the first electronic content layer 400 and the second electronic content layer 402, and the first user may create the third electronic content layer 402. The first user may share the third electronic content layer 402 with a second user, and the second users may create a private electronic content layer as the fourth electronic content layer 403 such that the edit and access permissions associated with the fourth electronic content layer 403 is limited to the second user.

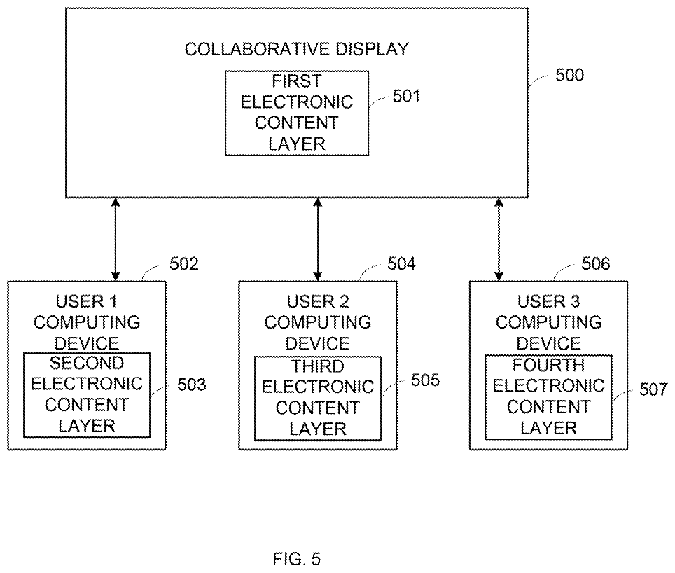

FIG. 5 is a diagram illustrating one example of a configuration used for collaboratively viewing and/or editing electronic content layers. The collaborative display 500 may be a display that is viewable by multiple users, such as by users 1, 2, and 3, and each user may have a computing device, such as computing devices 502, 504, and 506, which may be a tablets or mobile devices. The user computing devices 502, 504, and 505 may allow the users to provide input by creating or editing an electronic content layer, such as by electronically sketching using a smart pen or stylus, and the collaborative display 500 may allow users to view content created by the other users. The collaborative display 500 may be a display device in a room for video conferencing. In one implementation, the users view electronic content layers created by other users on the user computing devices 502, 504, and 506. In one implementation, the collaborative display 500 is shown on multiple devices available to multiple users, such as on individual computing devices. A computing system may allow a user to select which electronic layers to view. For example, on their computing devices, each user may choose to display the shared electronic content layers, the electronic content layers with access permissions limited to the particular user, or a combination of both. Multiple electronic content layers may be displayed in any suitable manner, such as either side-by-side, via an inset window, or superimposed one on top of the other.

As an example, the collaborative display 500 may show a first electronic content layer 501. The access permissions associated with the first electronic content layer 501 may make it accessible to users 1, 2, and 3. The users may each copy the first electronic content layer 501 to create their own versions of the first electronic content layer 501 such that the users may make individual contributions. For example, second electronic content layer 503, third electronic content layer 505, and fourth electronic content layer 507 may be edited by the individual users. The second electronic content layer 503, third electronic content layer 506, and fourth electronic content layer 507 may have private access permissions such that they are not shared with the other users. A user may select to share their content by changing the access information and selecting to share the information, such as to share the electronic content layer on the collaborative display 500. As an example, each user may take turns sharing their electronic content layer, and the other users may individual or as a group select one of the shared electronic content layers to use to create a new electronic content layer to make further edits on the same layer. In one implementation, content from multiple electronic layers may be superimposed on one another for viewing, such as to be displayed on the collaborative display 500. In one implementation, content from multiple electronic content layers created by different users may be manually or automatically merged to create a new electronic content layer to display on the collaborative display 500 such that the new electronic content layer may then be edited as a single layer. A computing system that allows for content to be created using layers that may be associated with edit and access permissions may promote collaboration.

1. A computing system, comprising:
a storage to store multiple electronic content layers, wherein each electronic content layer is associated with an edit permission type and an access permission type; and
a processor to:
store a first electronic content layer received from a first user computing device, wherein the first electronic content layer is associated with an edit permission type indicting the first user and is associated with an access permission type including a second user;
transmit information related to the first electronic content layer to a second computing device associated with a second user;
create a second electronic content layer based on the first electronic content layer, wherein the second electronic content layer is associated with an edit permission type associated with the second user;
transmit information related to the first electronic content layer to a third computing device associated with a third user; and
create a third electronic content layer based on the first electronic content layer, wherein the third electronic content layer is associated with an edit permission type associated with the third user.

2. The computing system of claim 1, wherein the processor is further to create a fourth electronic content layer based on content associated with the second electronic content layer and content associated with the third electronic content layer.

3. The computing system of claim 1, wherein the computing system comprises a display to display information about electronic content layers to the first and second user and wherein the first user computing device and the second user computing device comprise mobile computing devices.

4. The computing system of claim 1, wherein the processor is further store the second electronic content layer, wherein the second electronic content layer includes edits created by the second user.

5. The computing system of claim 1, wherein the processor is further to:
update the access permission associated with the second electronic content layer to include an additional user; and
provide information to the additional user related to the second electronic content layer.

6. A method, comprising:
storing a first electronic content layer created by a first user and associated with access permissions including a second and third user.
transmitting the first electronic content layer such that it is available to a second and third user;
creating, by a processor, a second electronic content layer based on the first electronic content layer as edited by the second user;
creating a third electronic content layer based on the first electronic content layer as edited by the third user; and
storing information related to the second and third electronic content layers and associated access permission types.

7. The method of claim 6, wherein the first sketch is received from a first computing device and the second sketch is edited by the second user using a second computing device.

8. The method of claim 6, wherein different access permissions are associated with the first, second, and third electronic content layers.

9. The method of claim 6, wherein a first section of the second sketch is associated with a first access permission type and a second section of the second sketch is associated with a second access permission type.

10. The method of claim 6, wherein associating a permission type with the third electronic content layer comprises associating a different permission with the third layer than with the components of the third electronic content layer.

11. The method of claim 6, further comprising automatically merging content from two other electronic content layers to create a fourth electronic content layer.

12. A machine-readable non-transitory storage medium comprising instructions executable by a processor to:
cause a user interface to be displayed to receive user input related to:
selecting a first electronic content layer created by a first user to copy to create a second electronic content layer and assign edit permission to the second electronic content layer;
editing the second electronic content layer; and
selecting access permissions information to associate with the second electronic content layer;
store information related to the second electronic content layer; and
publish information about the second electronic content layer to users with associated access permissions to the second electronic content layer.

13. The machine-readable non-transitory storage medium of claim 12, wherein the access permissions comprise at least one of: private, shared, and public access permissions.

14. The machine-readable non-transitory storage medium of claim 12, wherein instructions to associate permissions with the second electronic content layer comprises instructions to associate a different access permissions with the second electronic content layer than associated with the first electronic content layer.

15. The machine-readable non-transitory storage medium of claim 12, further comprising instructions to create a third electronic content layer based on a selection of a portion of the second electronic content layer.
